(19) United States
(12) Patent Application Publication
(10) Pub. No.: US 2006/0088627 A1
(43) Pub. Date: Apr. 27, 2006

(54) Methods for the production of food grade extracts

(75) Inventors: Daniel D. Bartnick, Indianapolis, IN (US); Charles Mark Mohler, Indianapolis, IN (US); Mike Houlihan, Avon, IN (US)

Correspondence Address: MICHAEL BEST & FRIEDRICH, LLP, 100 E WISCONSIN AVENUE, MILWAUKEE, WI, 53202, US

(73) Assignee: Sensient Flavors Inc.

(21) Appl. No.: 10/972,751

(22) Filed: Oct. 25, 2004

(51) Int. Cl. A23F 3/16

(52) U.S. Cl. 426/52

(57) ABSTRACT

Methods for producing food grade extracts, such as botanical extracts, with low processing times are provided. The methods include a reactive extraction step carried out at elevated temperatures and, optionally, an enzymatic treatment step conducted prior to or concurrently with the reactive extraction. In the reactive extractions one or more reactive agents are combined with a food solid substrate and a solvent medium and incubated to provide a flavoring extract resulting from reactions between the reactive agents and the food solid substrate.

### BACKGROUND

Extraction of botanical materials has existed for thousands of years, dating as far back as the ancient Egyptians producing beer from the extracts of malted barley and wheat, and perfumes extracted from flowers and spices. Traditional methods of botanical extraction consist of soaking the botanicals in water and/or other solvents (i.e., ethanol, hexane, propylene glycol, etc.) over extended periods of time, then separating out the insoluble fibrous plant material, resulting in a liquid extract from the botanical material possessing the organoleptic and olfactory characteristics of that botanical.

In order to enhance the flavor of a botanical extract additional flavoring ingredients (e.g., top noting ingredients), produced from a separate reaction, have been added to the extracts. This method of adding reacted flavors, post extraction, contributes to an uncharacteristic flavor perception sometimes with off notes in the final botanical extract, being perceived as unnatural. These types of botanical extraction mixtures need to be aged to fully organoleptically blend the added reacted flavor ingredients to the liquid botanical extract.

### SUMMARY

Methods for producing high quality food grade extracts from a variety of food solids, such as botanical materials, are provided herein. The present methods use a reactive extraction process whereby food solids are reacted with various reactive agents during an extraction process to produce new flavoring compounds. The basic process involves treating a food solid substrate in a solvent medium with a reactive agent and, optionally, an enzyme material to provide a food grade extract mixture. The present process results in food grade extracts having a more concentrated flavor and a superior taste profile compared to comparable extracts made from a two step extraction process where the reaction and extraction steps are separated.

The present methods often have relatively short processing times. By substantially reducing the amount of time required for production of the extract, plant capacity can be increased and processing costs can be lowered, without sacrificing flavor. In some embodiments, the combined processing time for the reactive extraction and any enzyme-treatment steps may require no more than about 10 hours. In some embodiments the overall process (enzyme treatment and reactive extraction) may be completed even more rapidly, e.g., the combination of enzymatic treatment and reactive extraction may be completed in no more than about 8 hours and, in some instances, may be completed in 5 hours or less.

The methods provided herein may use combinations of high temperatures, high pressures and/or enzyme treatment to enhance the production of food grade extracts. When an enzyme treatment is used the treatment may occur simultaneously with the reactive extraction, prior to the reactive extraction or a combination of both.

The present methods may be used to produce natural flavor extracts from a variety of food solid substrates. Examples of food solid substrates that may be treated in accordance with the present methods include, but are not limited to, botanical materials, such as herbs, spices, roots, vegetables, beans, fruit and legumes.

The reactive agents may be any food grade agents capable of reacting with the food solid substrate to produce flavoring compounds that would not be produced in the absence of the reactive agents As used herein the term “reactive agent” refers to compounds that are external to the food solid substrates. The reactive agents are incorporated into the process along with the food solid substrate and not as a part of the food solid substrate. Thus, compounds such as sugars or amino acids that are contained within the food solid substrate and that undergo reactions with the food solid substrate would not be considered reactive agents, while additional sugars or amino acids that are incorporated into the present processes would be considered reactive agents. Examples of reactive agents that may be used in the reactive extractions include, but are not limited to, sugars, natural amino acids, botanical extracts, yeast extracts, essential oils, natural alcohols, natural essences, nucleic acids, protein hydrozylates, natural organic acids and salts thereof, furfural, acetoin and mixtures thereof. Maillard reactions between the food solid substrates and sugars and/or amino acids are an illustrative example of a type of reaction that may occur during the reactive extractions.

In one embodiment of the process, a reactive extraction is carried out at elevated temperatures by contacting a food solid substrate with a solvent medium and a food grade reactive agent at elevated temperatures. The solvent medium may contain a food grade organic solvent and/or water. In some instances the solvent medium is an aqueous solvent medium containing water and one or more food grade organic solvents which are miscible with water in the proportions employed, such as a food grade alcohol. An aqueous solvent medium will contain a substantial amount, but not necessarily a majority, of water, based on the liquid components of the medium. For example, in some embodiments the aqueous solvent medium may contain up to about 75 weight percent (wt. %) organic solvent based on the liquid components of the medium. In other instances the aqueous solvent medium will be a substantially aqueous solvent medium wherein water accounts for a substantial majority of the liquid content of the medium. For example, in some embodiments a substantially aqueous solvent medium may contain at least about 70 wt. % water, based on the liquid components of the medium. Some of the present processes will employ an aqueous solvent medium that is substantially free of (e.g., contains no more than about 5 wt. % and desirably no more than about 1 wt. %) organic solvents.

Suitable organic solvents for use in the present reactive extraction processes include food grade alcohols, vegetable oils, animal fats and the like. In some embodiments the food grade alcohol may be an alkanol having no more than 4 carbon atoms (or a mixture thereof). Butanol, ethanol, isopropanol or a mixture thereof are commonly employed. Low molecular weight glycols and polyols, such as propylene glycol (i.e. 1,2-propanediol), butylene glycol and glycerin, or esters of polyols, such as triacetin may also desirably be used.

The reactive extraction is desirably, but not necessarily, carried out by agitating a mixture (e.g., a fluidized slurry) which includes a food solid substrate, a solvent medium (desirably an aqueous solvent medium) and a food grade reactive agent in a sealed reactor to produce an extract mixture comprising flavor components resulting from reactions between the food solid substrate and the reactive agent. The reactive extraction is typically carried out at elevated temperatures and elevated pressures which result from the heating of the mixture in a sealed reactor. Typically the reactive extraction temperature will range from about 130 to 250° F. (e.g., at least about 190° F.) and the pressure in the sealed reactor will be at least about 10 psig, although in some instances it may be considerably higher.

The food solid substrate content of the mixture in which the reactive extraction takes place may be quite high. For example, in some instances the mixture may contain at least about 10 wt. % food solid substrate. This includes embodiments where the mixture contains at least about 15 wt. % food solid substrate, further includes embodiments where the mixture contains about 50 wt. % food solid substrate and still further includes embodiments where the mixture contains about 75 wt. % food solid substrate.

The reactive agent may account for a relatively low amount of the extraction mixture (i.e., the total amount of food solids and liquid(s) present in the extraction mixture). For example, in some reactive extractions reactive agent will account for about 0.1 to 5 wt. % (e.g., about 0.5 to 5 wt. %) of the extraction mixture. For example, in some illustrative embodiments reactive agent will account for about 1 to 3 wt. % of the extraction mixture. However, in some embodiments of the reactive extractions, reactive agent may account for a significantly larger percentage of the extraction mixture (e.g., about 5 to 20 wt. %, at least about 20 wt. %, at least about 30 wt. %, or even higher.) Still greater amounts of reactive agent may be desirable in other embodiments in order to achieve specific flavor profiles and/or intensities.

The elevated temperature reactive extraction may optionally be preceded by or occur simultaneously with an enzymatic digestion of the food solid substrate. When the reactive extraction is preceded by an enzymatic digestion, the enzymatic digestion typically will be conducted at a somewhat lower temperature to avoid premature inactivation of the enzyme material. When the reactive extraction occurs simultaneously with an enzymatic digestion, the reactive extraction will typically occur in two heating stages. In the first heating stage the mixture is heated at a temperature low enough to avoid substantial inactivation of the enzymatic material. In the second heating stage the mixture is heated to a higher temperature. Suitable enzymes include those with glycosidase activity. As used herein “glycosidase activity” refers to the capability of a hydrolase enzyme to attack glycosidic bonds in carbohydrates and glycoproteins. For the purposes of this disclosure a glycosidic bond refers to the bond between the anomeric carbon of a carbohydrate and another group. The extraction may be enhanced by conducting the enzymatic digestion at elevated pressures. The use of elevated pressures and a sealed reactor can reduce the opportunity for the loss of volatile compounds that can occur under ambient pressure conditions.

The enzymatic digestion of the food solid substrate typically takes place in a aqueous solution of the food solid substrate and the enzyme in water. Additionally, an organic solvent, such as a food grade alcohol, may be added to the enzymatic digestion solution provided the organic solvent will not significantly affect the enzyme activity. For example, low molecular weight polyols, such as propylene glycol, butylene glycol or glycerin, may generally be included in the enzymatic digestion solution without denaturing the enzymes. If it is desired to use organic solvents that might affect enzyme activity it may be advantageous to add these solvents to the mixture after the enzymatic digestion step. Similarly, if the reactive agents selected for a given reactive extraction will affect enzyme activity significantly, it may be advantageous to separate the enzyme treatment and reactive extraction steps.

Typically, the enzymatic digestion process may be carried out at a temperature of at least about 70° F., but desirably no greater than about 150° F. Exposure to relatively high temperatures can lead to denaturation of the enzyme material and loss of activity. Temperatures of about 100° to 180° F. are generally quite suitable for carrying out the enzyme digestion. The minimum processing pressures in the reactor during the enzymatic treatment and extraction steps will be dictated by the vapor pressures of the solvents at the processing temperatures. In a typical embodiment, the pressure in the reactor for the extraction step will be at least about 10 psig (e.g., about 10 to 15 psig).

The reactive extraction and optional enzymatic treatment steps described above yield a food grade extract mixture. Depending on the desired consistency of the final product, the extract mixture may be used “as is” or the solids remaining after the extraction may be filtered out. Depending on the desired level of flavor in the final product, the extract mixture may be concentrated by removing (e.g., via evaporation) some of the solvent medium. Alternatively, additional solvent medium (e.g., water and/or organic solvent) may be added to the extract mixture to produce a more dilute composition.

### DETAILED DESCRIPTION

Methods for producing food grade extracts are provided. The methods can produce food grade extracts with enhanced flavor while substantially reducing the processing time required to obtain the extracts.

As used herein, the phrase “food grade” means that up to specified amounts of the particular compound can be ingested by a human without generally causing deleterious health effects. Examples of food grade compounds include those compounds “generally recognized as safe” (“GRAS”) by the United States Food and Drug Administration (“FDA”). In particular, food safe compounds include those compounds listed as approved under 21 C.F.R. §§ 73, 74, 172, 182 and 184.

In some instances, the methods provided herein may be used to produce food grade extracts from botanical materials such as herbs, spices, roots, vegetables, fruit, legumes and beans, where the term “bean” is used broadly to include the seeds and fruits of a variety of plants (not only plants in the legume family) that are commonly referred to as beans (e.g., coffee beans, cocoa beans and vanilla beans). Specific examples of suitable food solid substrates from which extracts may be obtained include, but are not limited to, coffee beans (including roasted coffee beans), tea leaves, cocoa beans (including cocoa nibs), garlic and onions. The botanical materials may be whole or comminuted.

The advantages realized by the present methods stem, at least in part, from the reactions between reactive agents and food solid substrates that occur during the extraction process. This reactive extraction may be accomplished by incubating a food solid substrate and a reactive agent in a solvent medium at elevated temperatures for a time sufficient to allow for the reaction between the reactive agent and the food solid substrate and the release of the resulting flavoring agents. The reactive extraction may be carried out in any suitable reactor. However, the reaction is desirably carried out in a sealed reactor to prevent the escape of volatile flavoring components.

The reactive agent may be any food grade agent capable of reacting with the food solid substrate to provide flavoring compounds. Examples of reactive agents that may be used in the reactive extractions include, but are not limited to, sugars, natural amino acids, botanical extracts, essential oils, natural alcohols, natural essences, nucleic acids, protein hydrozylates, natural organic acids and salts thereof, furfural, acetoin and mixtures thereof. Maillard reactions between the food solid substrates and sugars and/or amino acids are an illustrative example of a type of reaction that may occur during the reactive extractions. Many of the reactive agents are compounds of the type a flavorist might use as top noting agents in conventional flavorings. These include, acids and bases, alcohols, aldehydes, amines, amides, amino acid salts (e.g., monosodium glutamate), botanical extracts (extracts of fruits, vegetables, spices, herbs, etc.), buffers, carotinoids, coloring agents, ethers, essential oils, essences (fruits, flowers, vegetables etc.), esters, fats and oils, fatty acids, gums, ketones, lactones, meat extractives (from fats, flesh, bones, by-products etc.), mercaptans, nucleic acids (e.g., guanosine monophosphate (GMP) and inosine monophospate (IMP)), oxides, proteins, polypeptides, amino acids, proteins (including hydrolyzed proteins), preservatives, antioxidants, pyrazines, salts, sequestrants, starches, sugars, sulfides, terpenes, thiazoles, vitamins, and waxes.

The amount reactive agent in a reactive extraction will depend on a variety of factors, including the nature of the food solid substrate, the nature of the reactive agent and the desired amount of flavoring. For example the reactive extractions may include one or more of each of the following classes of compounds in the recited concentrations (provided in wt. % of the extraction mixture): 1) sugars—about 0.1 to 30 wt. %; 2) natural amino acids—about 0.1 to 5 wt. %; 3) botanical extracts—about 0.1 to 50 wt. %; 4) protein hydrozylates—about 1 to 10 wt. %; 5) essential oils—about 0.001 to 5 wt. %; 6) natural alcohols—about 0.1 to 5 wt. %; 7) natural essences—about 1 to 50 wt. %; 8) nucleic acids—about 1 to 5 wt. %; 9) natural organic acids—about 0.1 to 5 wt. %; and 10) furfural and/or acetoin—about 0.001 to 5 wt. %. However, the present methods are not limited to those that employ these compounds in the cited ranges.

Specific examples of natural amino acids that may be used as reactive agents include, but are not limited to, cysteine, phenylalanine, proline and salts thereof. Specific examples of sugars that may be used as reactive agents include, but are not limited to, dextrose, rhamnose, xylose and arabinose. Specific examples of botanical extracts that may be used as reactive agents include, but are not limited to, vanilla extract, quillaia extract, mate leaf extract, coffee extract, cocoa extract, chicory root extract, rose hip extract, fenugreek seed extract, green tea leaf extract and carob extract. Specific examples of essential oils that may be used as reactive agents include, but are not limited to, sesame oil, garlic oil, parsley leaf oil, cinnamon bark oil and cubeb oil. Specific examples of natural essences that may be used as reactive agents include, but are not limited to, flower essences, vegetable essences and fruit essences. Specific examples of nucleic acids that may be used as reactive agents include, but are not limited to, guanosine monophosphate (GMP) and inosine monophosphate (IMP). Specific examples of protein hydrozylates that may be used as reactive agents include, but are not limited to, yeast extracts and hydrolyzed vegetable proteins. Specific examples of natural alcohols that may be used as reactive agents include, but are not limited to, hexanol, heptanol, hexenol and maltol. Specific examples of natural organic acids that may be used as reactive agents include, but are not limited to, butter acids, sorbic acid, ascorbic acid, acetic acid, citric acid and salts thereof. These reactive agents may be natural or synthetic, provided they are capable to producing a food grade extract. As used herein, the term “natural” means derived from a natural source.

One or more compounds selected from one or more of the categories described above may be mixed to provide the reactive agent. Illustrative examples of such mixtures include mixtures of one or more natural amino acids or salts thereof, one or more sugars and one or more botanical extracts. Such a mixture may further include one or more additional compounds selected from yeast extracts, essential oils, natural alcohols and furfural. Another illustrative example is a mixture containing one or more yeast extracts, one or more sugars and one or more essential oils. Such a mixture may further include one or more natural alcohols and/or one or more natural organic acids or salts thereof.

The solvent medium employed in the reactive extraction (and in any enzymatic digestion step, as described below) should be a food grade solvent medium. The solvent medium may be an aqueous medium that contains a substantial amount of organic solvent. For example a suitable aqueous solvent medium may contain up to about 75 wt. % organic solvent, based on the liquid content of the medium. This includes aqueous solvent mediums that contain about 10 to 60 wt. % organic solvent, based on the liquid content of the medium and further includes aqueous solvent mediums that contain about 20 to 50 wt. % organic solvent, based on the liquid content of the medium. The solvent medium be an aqueous medium that contains a substantial majority of water. For example the aqueous solvent medium may contain at least about 70 wt. % water, at least about 80 wt. % water or even at least about 90 wt. % water based on the liquid content of the medium. In some instances the aqueous solvent medium will be substantially free of organic solvent. For example the aqueous solvent medium may contain no more than about 5 wt. % organic solvent, desirably no more than about 1 wt. % organic solvent and more desirably no more than about 0.5 wt. % organic solvent, based on the liquid content of the medium. In some instances the aqueous solvent medium will be free of organic solvent.

The organic solvent concentration in the aqueous solvent medium may be adjusted during the reactive extraction process by introducing additional organic solvent and/or water into the reactor during the extraction process. The organic solvents used in the reactive extractions are desirably food grade alcohols. Propylene glycol, butylene glycol and glycerin are favored alcohols because they are food grade polyols that may be used in an enzymatic digestion step prior to or concurrently with extraction without significantly affecting the activity of the enzymes. This makes it possible to carry out both the enzymatic digestion and the reactive extraction in the same solvent. Other suitable alcohols include ethanol and butanol which have been approved by the U.S. Food and Drug Administration for use in extracts. However other alcohols, such as isopropanol, may also be used provided they are subsequently removed to an extent sufficient to provide a food grade product. Other suitable food grade organic solvents include vegetable oils and animal fats.

The reactive extraction may advantageously be carried out at elevated temperatures. In some embodiments, the temperature of the reactor contents during the reactive extraction step is at least about 130° F. This includes embodiments where the temperature of the reactor contents during the reactive extraction step is at least about 150° F., and further includes embodiments where the temperature of the reactor contents during the reactive extraction step is at least about 190° F. Reactive extraction temperatures of about 190 to 240° F. are commonly quite suitable. However, the reactive extraction may be conducted at considerably higher temperatures. For example, reactive extractions may be carried out at temperatures of at least about 250° F. (e.g., temperatures of about 350 to 400° F.). The reactive extraction step is commonly carried out by introducing the solvent medium into a reactor containing a food solid substrate, such as coffee beans, under ambient conditions. The reactor is then sealed and pressure is generated within the reactor by heating the contents. If the reactor is sealed, the minimum pressure during the reactive extraction step will depend on the vapor pressure of the solvent medium, which is influenced by the temperature in the reactor. In some reactive extractions the pressure in the reactor will be at least about 10 psig. This includes embodiments where the reactive extractions are carried out at pressures of at least about 20 psig, at least about 50 psig, at least about 100 psig or even higher. Pressures of about 10 to 60 psig can commonly be attained by heating an aqueous solvent medium in a sealed reactor at temperatures of about 180 to 250° F. For example, when a substantially aqueous medium is used at temperatures of about 210° F. in a sealed reactor, the extraction pressure will typically range from about 10 psig to about 20 psig.

The combination of the reaction and extraction steps in accordance with the present methods reduces the total processing time considerably compared to methods where the reactions and extraction take place in separate steps. In some instances, the reactive extraction, including any enzymatic treatments, may take no more than about 10 hours and in some cases, no more than about 8 hours. This includes embodiments where the reactive extractions, including any enzymatic treatments, take no more than about 5 hours. For the purposes of this disclosure, the duration of the reactive extraction step is the total time that the food solid substrate and reactive agents in the solvent medium are exposed to elevated temperatures in a sealed vessel. The duration of any separate enzymatic treatment step is the total time that the food solid substrate is undergoing enzymatic digestion. As used herein an elevated temperature is any temperature that has been increased above ambient temperature.

During the reactive extraction, a fluidized slurry of the food solid substrate and solvent medium may be agitated, typically either in a regular or continuous manner. For example, the slurry may be continuously agitated by stirring the slurry with a paddle or plow within the reactor. This can enhance the interaction and contact between the solvent medium, the food solid substrate, and the reactive agent, and may aid in breaking down the food solids into smaller particles.

The methods provided herein may optionally include an enzymatic treatment step prior to or simultaneous with the reactive extraction step. Although the enzymatic material in the enzymatic treatment may be reacting with the food solid substrate to provide new flavoring agents, for the purposes of this disclosure enzymes are not considered “reactive agents.” Instead any enzymatic treatments are considered to be occurring in addition to and not as part of the reactive extraction reactions. When an enzymatic treatment step is included, the food solid substrate and a suitable enzymatic material are placed together with a first aqueous medium in a reactor. A mixture of the enzyme-treated food solid substrate, a second aqueous medium and reactive agent is then heated to provide an extract mixture. In some instances, as when the enzyme treatment and the reactive extraction take place simultaneously, the first and second aqueous media are the same.

The enzymatic material generally contains one or more enzymes having glycosidase activity, such that the material is capable of at least partially breaking down the fiber matrix of the food solids, such as botanical materials. Desirable glycosidase activities include cellulase activity, hemicellulase activity, xylanase activity, pectinase activity, galactomannanase and/or β-glycosidase activity. The enzyme material commonly includes glucosidase activity, and in particular β-glucosidase activity. Suitable commercially available enzymatic materials include, but are not limited to, Depol 40L enzyme material from Biocatalysts Limited, Wales UK, Crystalzyme Concord enzyme material from Valley Research, Inc., South Bend, Ind., DP-378 and Enzyme Cellulase 4000 from Valley Research, Inc., South Bend, Ind. In certain embodiments of the present method, enzyme materials which include cellulase activity, hemicellulase activity, pectinase activity and glucosidase activity may be particularly suitable. In other embodiments, the enzyme material may include cellulase activity, xylanase activity, pectinase activity, and β-glucosidase activity. In still other embodiments, the enzyme material may include cellulase activity, hemicellulase activity and galactomannanase activity.

In some embodiments, in order to maintain the optimum activity of the enzyme material, the solvent medium employed for the enzyme treatment desirably contains no more than about 20 wt. % organic solvent (e.g., food grade alcohol or polyol); commonly no more than about 10 wt. % organic solvent or even no more than about 5 wt. % organic solvent, based on the liquid content of the solvent medium. In many instances, it is preferable to conduct the enzyme treatment in an aqueous medium that is free of or substantially free of organic solvent, e.g., contains no more than about 1 wt. % alcohol. However, higher levels of organic solvent may be present during the enzyme treatment when organic solvents that do not have a significant negative impact on enzyme activity are employed. For example, in some instances higher levels of polyols, such as propylene glycol, butylene glycol and glycerin may be included in the enzymatic digestion medium because they generally do not deactivate enzymes of the type described herein. If inactivation of the enzyme material is a concern, the enzymatic digestion step may be carried out prior to the reactive extraction and in a different solvent medium.

While food solid substrates may be used in unaltered forms as starting materials for the present processes, the food solids are commonly comminuted prior to the reactive extraction. This can enhance the efficiency of the operations. For example, when the present process is used to produce an extract from beans, such as coffee, cocoa or vanilla beans, the beans are typically comminuted into pieces, either prior to the reactive extraction or any optional enzyme treatment or during the initial stages of the process. Comminuting the food solids increases their surface area and can enhance the efficiency of the reactive extraction process. For example, when processing beans according to the present methods, it is generally advantageous to break the beans into smaller pieces while avoiding breaking the solid material down into a finer material which is capable of absorbing substantial quantities of extraction liquid. By way of illustration only beans are suitably chopped to provide material having an average particle size of about ⅛ to 1.5 inch. This includes embodiments where the beans have an average particle size of about ⅛ to ¾ inch and further includes embodiments where the beans have an average particle size of about ⅛ to ⅜ inch. The beans may be chopped or ground prior to processing or, in some instances, the beans may be comminuted by the processing conditions, e.g., during the initial stages of the enzymatic treatment or the extraction. This may be accomplished by carrying these operations in a reactor equipped with a suitable mixing plow and/or chopping blade.

For reactive extractions that include a simultaneous enzymatic digestion, the temperature in the reactor may be elevated above room temperature, however, it should generally remain below the temperature at which significant denaturation of the enzymes occurs at least during an initial stage of the process when both enzymatic digestion and reactive extraction are taking place. Thus, the maximum temperature for the enzymatic treatment will depend on the nature of the enzyme material being employed. Typically, however, enzymatic treatment will take place at a temperature of no more than about 180° F. (roughly 82° C.) and more typically at a temperature from about 100 to 140° F. (circa 38 to 60° C.). The enzyme treatment is desirably continued for a period of time sufficient to at least partially break down the fiber matrix of the food solid substrate, after which the temperature in the reactor may be increased to continue the reactive extraction process.

The extract mixture that has been produced using the reactive extraction with or without an enzymatic treatment may be used without modification as a flavoring agent. Alternatively, the liquid contents of the reactor may be removed from the reactor through a filter or sieve in order to separate the remaining solids. This may be accomplished by a simple gravity filtration. In some embodiments, the removal of the liquid extract from the solids may be assisted by flushing the residual solids with additional portion of solvent. In other embodiments, the liquid extract may be forced out of the reactor by introducing a pressurized gas, such as air or nitrogen, to the reactor or by applying a partial vacuum to the outlet side of the filter to draw the liquid away from the residual solid material. When it is desirable to minimize the loss of volatile flavor components in the extract mixture gravity filtration of the liquid extract from the extraction slurry followed by washing the residual solids with a small amount of additional solvent may provide a suitable separation/recovery operation. The reactive extraction operation or combined enzyme treatment/reactive extraction operation may be repeated multiple times on the same sample of food solid substrate.

The filtered extract may optionally be clarified by removing at least a portion of the food grade solid substrate from the extract (e.g., using a pressure plate filtration). If desired, the clarified extract may be further concentrated by evaporating away a portion of the solvent medium or diluted with additional water and/or organic solvent, depending on the desired strength of the final extract.

One general exemplary method for producing a food grade extract is described as follows. A quantity of food solid substrate is placed into a suitable reactor fitted with a paddle or plow blade, such as a Littleford-Day DVT Pressure/Vacuum Reactor. An aqueous solvent medium, such as water or a water/organic solvent mixture, reactive agent and, optionally, an enzyme material are then introduced into the reactor at ambient pressure and the reactor is sealed. The food solids may be processed whole, but they may also desirably be chopped or ground prior to processing. For example, when whole beans, such as coffee beans or cocoa beans, are introduced into the reactor together with the solvent medium, the whole beans may be broken into pieces by the action of a plow blade or chopper blade used to agitate the mixture in the reactor. In some instances, it may be advantageous to agitate the mixture with the paddle/plow blade at a relatively high rate for an initial period of time to break up the food solids, followed by a more gentle agitation during the remaining period of time that the reactive extraction is carried out. As indicated herein, it is generally advantageous to break the food solids into pieces while avoiding breaking the solid material down into a finer material which would be capable of absorbing larger quantities of liquid.

The sealed reactor is then heated to an elevated temperature, typically at least about 130° F. and, more commonly at least about 150° F. (e.g., about 190° F. to 220° F.). When an enzyme material is present the heating may take place in two stages. Typically reactor contents will be heated to a temperature of no more than about 130° F. in a first stage and to a temperature of at least about 190° F. in a second stage. Due to the vapor pressure of the solvent medium, this generates a increased pressure in the reactor. For example, if the solvent medium is introduced into the reactor at ambient pressure, sealing the reactor and heating the contents to temperatures of 130° F. and above can generate a pressure which is greater than ambient pressure. If water or an aqueous alcohol solvent, such as aqueous 1,2-propanediol or glycerin solvent is employed as an aqueous solvent medium, heating the reactor contents to such temperatures can generate pressure of at least about 10 psig, although higher pressures may be used. For example, pressures of about 10 to about 30 psig can commonly be produced by heating aqueous alcohol solvents to temperatures of about 190° F. to 220° F. in a sealed reactor.

The food solid substrate and reactive agent are then incubated for a period of time, typically about one to five hours. After cooling, the extract mixture may be discharged through a filter or sieve to separate the residual solids from the liquid extract. Suitable filters include Filtorr® filters available from Littleford Day, Florence Ky. Suitable external sieves include filtrations units available from Sweco, Florence, Ky., and Sparkler Filters Inc., Conroe, Tex. The grade of filter or the mesh of sieve may vary depending upon the desired clarity of the extract. The remaining food solids are then removed from the reactor.

Extracts produced according to the present processes may be used to flavor a variety of food products. Such products include, but are not limited to, confectionary products, drink products (i.e. beverages), frozen desserts, baked goods, breakfast cereals, condiments, dairy products, including pasteurized dairy products, canned or frozen foods and pre-packaged meals. Specific examples of confectionary products include chocolates, mousses, chocolate coatings, yogurt coatings, cocoa, frostings, fillings, toppings, candies, energy bars and candy bars. Beverages that may be flavored with the food grade extracts include both still and carbonated beverages. Specific examples of beverages include smoothies, infant formulas, fruit juice beverages, yogurt beverages, coffee beverages, alcoholic beverages, tea fusion beverages, sports beverages, sodas and slushes. The food grade extracts may also be used in the production of dry and frozen beverage mixes. Specific examples of frozen desserts include ice cream, sorbet, frozen yogurt, frozen custard, ice milk and frozen novelty desserts. Specific examples of baked goods include cookies, crackers, graham crackers, breads, cakes, pies, rolls, snack bars, breakfast bars and pastries, such as doughnuts and danish. Specific examples of condiments that may be flavored with the food grade extracts include gravy and barbecue sauces. Specific examples of diary products include yogurt. Specific examples of canned foods include soups. Specific examples of frozen foods included frozen vegetables. Specific examples of pre-packaged meals include frozen dinners and microwavable dinners. It should be understood that the exemplary food products provided herein are for illustrative purposes only and are not meant to be an exhaustive list. It should also be understood that there will be overlap between the food product categories listed above, with some food products falling into two or more categories.

In general, the food grade extracts may be used to flavor the food products by adding the extracts to the food products in an effective flavoring amount. As used herein, an effective flavoring amount is any amount that produces a food product having a desire degree of flavoring. This amount may vary depending on the nature of the food product, the nature of the extract and the desired degree of flavoring. In some exemplary applications, the food grade extracts are added to the food products in sufficient quantities to produce food products that contain from about 0.01 to 1 weight percent food grade extract. This includes embodiments where the food grade extracts are added to food products in sufficient quantities to produce food products that contain from about 0.05 to 0.5 weight percent extracts. However, the food products provided herein are not limited to food products containing quantities of food grade extracts in these ranges.

### EXAMPLES

Exemplary embodiments of the present methods for producing food grade extracts are provided in the following examples. The following examples are presented to illustrate the methods and to assist one of ordinary skill in using the same. The examples are not intended in any way to otherwise limit the scope of the invention.

Equipment

The reactor used to produce the food grade extracts in the examples below was a Littleford-Day Model DVT-130 Polyphase Pressure/Vacuum Reactor. This reactor has a 35 gallon total capacity (22.8 gallon working capacity) horizontal cylindrical tank made of 304 stainless steel construction with a charging port on the top, a bottom discharge port and a door on the side to discharge the spent food solids. It has a 15 HP variable speed drive moving plow shaped mixing element that completely sweeps the inside surface of the reactor using a variable drive from 0-160 rpm, a 10 HP two speed high shear impact chopper running at 1800 and 3600 rpm, and a 100 psig heat transfer jacket heated by both generated hot water and steam. It has the capability of internal pressure up to 250 psig. It also has capacity for high vacuum service down to less than about 10 mm Hg, and can be fitted with a filter (Filtorr®) system at the discharge port with various mesh screens. Models are available up to 6,605 gallon total capacity.

### Example 1

### Preparation of a Natural Coffee Extract

A quantity of 15 kg blended and ground coffee beans, 83.9 kg water, 0.4 kg of a mixture of DP-378 and Cellulase 4000 (enzyme preparation from Valley Research) and 0.8 kg of reactive agent including at least one natural amino acid, at least one botanical extract, at least one essential oil, at least one natural alcohol, at least one sugar and at least one natural organic acid is charged into a Littleford Day DVT-130 reactor. The reactor is sealed and heated to approximately 130° F. via steam injection into a jacket. The reactor contents are agitated at about 15 Hz and reactive extraction is allowed to proceed for about one hour. The temperature in the reactor is then increased to 212° F., producing a 10-15 psig internal pressure, and the reactive extraction is allowed to proceed for an additional 30 minutes. The reactor contents are then cooled to room temperature. The resulting extract is discharged through a 30-mesh Filtorr® screen on the bottom of the reactor. The extract is then clarified using pressure plate filtration. The total processing time is approximately 3-5 hours.

### Example 2

### Preparation of a Natural Green Tea Extract

A quantity of 10 kg green tea leaves, 38.2 kg water and 0.2 kg of a mixture of DP-378 and Cellulase 4000 (enzyme preparation from Valley Research) are charged into a Littleford Day DVT-130 reactor. The reactor is sealed and heated to approximately 130° F. via steam injection into a water filled jacket. The reactor contents are agitated at about 15 Hz and enzyme treatment is allowed to proceed for about one hour. The green tea leaves then transferred to a cheese cloth bag which is charged into a reactor along with the water, 38.2 kg 1,2 propanediol, 0.8 kg sodium hydroxide and 12.9 kg of reactive agent including at least one natural amino acid, at least one botanical extract, at least one essential oil, at least one natural alcohol, at least one sugar and at least one natural organic acid. The reactor is closed and the liquid contents of the reactor are heated to approximately 158° F. and recirculated over the green tea leaves for a period of two days. The resulting extract is then drained from the reactor and condensed by vacuum evaporation to 50% of its liquid weight. The total processing time is approximately 50-52 hours.

### Example 3

### Preparation of a Natural Tea Extract

A quantity of 25 kg tea leaves, 73.2 kg water, 0.4 kg 1,2-propanediol, 0.4 kg of a mixture of DP-378 and Cellulase 4000 (enzyme preparation from Valley Research) and 1 kg of reactive agent including at least one sugar, a yeast extract, at least one botanical extract, at least one natural amino acid, furfural and at least one natural organic acid are charged into a Littleford Day DVT-130 reactor. The reactor is sealed and heated to approximately 130° F. via steam injection into a jacket. The reactor contents are agitated at about 15 Hz and reactive extraction is allowed to proceed for about one hour. The temperature in the reactor is then increased to 212° F. and the reactive extraction is allowed to proceed for an additional 30 minutes. The reactor contents are then cooled to room temperature. The resulting extract is discharged through a 30-mesh Filtorr® screen on the bottom of the reactor. The total processing time is approximately 3-5 hours.

### Example 4

### Preparation of a Natural Garlic Extract

A quantity of 82.4 garlic pods, 7.6 kg water, 2.5 kg of a mixture of Depol 40L (enzyme preparation from Biocatalysts) and 2.7 kg of reactive agent including at least one natural alcohol, at least one natural organic acid at least one essential oil, yeast extract and at least one sugar are charged into a Littleford Day DVT-130 reactor. The reactor is sealed and heated to approximately 150° F. via steam injection into a jacket. The reactor contents are agitated at about 15 Hz and reactive extraction is allowed to proceed for about two hours. The temperature in the reactor is then increased to 195° F. and the reactive extraction is allowed to proceed for an additional 30 minutes. The reactor contents are then cooled to room temperature. The resulting extract is discharged through a 20-mesh Filtorr® screen on the bottom of the reactor. A quantity of 4.9 kg of reactive agent including at least one natural alcohol, at least one natural organic acid, at least one essential oil, yeast extract and at least one sugar is then added to and blended with the filtered extract and the resulting blend is condensed by heating at 345° F. and evaporating off water. The Brix of the extract is adjusted to 60 by adding distillate followed by refrigeration. The total processing time is approximately 5-7 hours.

### Example 5

### Preparation of a Natural Cocoa Extract

A quantity of 18 kg cocoa bean nibs and 1 kg blended and ground coffee beans, 58.2 kg water, 20 kg 1,2-propanediol, 0.4 kg of a mixture of DP-378 and Cellulase 4000 (enzyme preparation from Valley Research) and 2.5 kg of reactive agent including at least one natural amino acid, yeast extract, furfural, at least one botanical extract, at least one sugar, at least one essential oil and acetoin are charged into a Littleford Day DVT-130 reactor. The reactor is sealed and heated to approximately 130° F. via steam injection into a jacket. The reactor contents are agitated at about 15 Hz and reactive extraction is allowed to proceed for about one hour. The temperature in the reactor is then increased to 220° F., producing a 10-20 psig internal pressure, and the reactive extraction is allowed to proceed for an additional hour. The reactor contents are then cooled to room temperature. The resulting extract is condensed by 60% by vacuum evaporation. The total processing time is approximately 4-6 hours.

The invention has been described with reference to specific and illustrative embodiments. However, it should be understood that many variations and modifications may be made while remaining within the spirit and scope of the invention.

What is claimed is:

1. A process for the production of a food grade extract comprising:
(a) treating solid botanical substrate in a first aqueous medium with an enzyme material having a glycosidase activity; and
(b) heating a mixture, which comprises the enzyme-treated solid botanical substrate, a second aqueous medium, and a food grade reactive agent to provide an extract mixture.

2. The process of claim 1 wherein the first aqueous medium and the second aqueous medium are the same.

3. The process of claim 1 wherein the food grade reactive agent includes one or more components selected from natural amino acids, sugars, botanical extracts, essential oils, natural essences, nucleic acids and protein hydrozylates.

4. The process of claim 3 wherein the food grade reactive agent comprises one or more natural amino acids or salts thereof; one or more sugars and one or more botanical extracts.

5. The process of claim 4 wherein the food grade reactive agent further comprises yeast extract.

6. The process of claim 4 wherein the food grade reactive agent further comprises one or more essential oils.

7. The process of claim 4 wherein the food grade reactive agent further comprises furfural.

8. The process of claim 4 wherein the food grade reactive agent further comprises one or more natural alcohols.

9. The process of claim 3 wherein the food grade reactive agent comprises one or more yeast extracts, one or more sugars and one or more essential oils.

10. The process of claim 10 wherein the food grade reactive agent further comprises one or more natural alcohols and one or more natural organic acids or salts thereof.

11. The process of claim 1 wherein the solid botanical substrate comprises garlic, onion or a mixture thereof.

12. The process of claim 1 wherein the solid botanical substrate comprises fruit, vegetable, spice, herb or a mixture thereof.

13. The process of claim 1 wherein the solid botanical substrate comprises coffee beans, cocoa beans, tea leaves or a mixture thereof.

14. The process of claim 13 wherein the coffee beans comprise comminuted, roasted coffee beans.

15. The process of claim 1 further comprising removing a least a portion of the second aqueous medium from the extract mixture to provide a concentrated extract mixture.

16. The process of claim 1 further comprising removing a least a portion of solid botanical substrate present in the extract mixture to provide a clarified extract mixture.

17. The process of claim 16 further comprising removing a least a portion of solvent from the clarified extract mixture to provide a concentrated clarified extract mixture.

18. The process of claim 1 wherein the second aqueous medium comprises one or more food grade alcohols.

19. The process of claim 18 wherein the food grade alcohol comprises ethanol, propanediol, glycerin, isopropanol or a mixture thereof.

20. The process of claim 1 wherein the first aqueous medium comprises one or more food grade alcohols.

21. The process of claim 1 wherein the mixture is heated at a temperature of at least about 150° F. in a sealed reactor at a pressure of at least about 10 psig.

22. The process of claim 21 wherein the food grade reactive agent includes one or more components selected from natural amino acids, sugars, botanical extracts, essential oils, natural essences, nucleic acids, protein hydrozylates, natural alcohols, natural organic acids and salts thereof.

23. The process of claim 22 wherein the natural amino acids comprise one or more of cysteine, phenylalanine, proline and salts thereof.

24. The process of claim 22 wherein the sugars comprise rhamnose, xylose, arabinose, dextrose or a mixture hereof.

25. The process of claim 22 wherein the botanical extracts comprise vanilla extract, quillaia extract, mate leaf extract, coffee extract, cocoa extract, chicory root extract, rose hip extract, fenugreek seed extract, green tea leaf extract, or a mixture thereof.

26. The process of claim 22 wherein the essential oils comprise sesame oil, garlic oil, parsley leaf oil, cinnamon bark oil, cubeb oil, or a mixture thereof.

27. The process of claim 22 wherein the nucleic acids comprise guanosine monophosphate, inosine monophosphate or a mixture thereof

28. The process of claim 22 wherein the protein hydrozylates comprise yeast extract, hydrolyzed vegetable protein or a mixture thereof.

29. The process of claim 22 wherein the natural alcohols comprise hexanol, heptanol, maltol, hexenol, or a mixture thereof.

30. The process of claim 22 wherein the natural organic acids comprise butter acids, sorbic acid, ascorbic acid, citric acid, or a mixture thereof.

31. The process of claim 21 wherein the food grade reactive agent includes a component selected from flower essences, vegetable essences, fruit essences or mixtures thereof.

32. The process of claim 1, further comprising agitating the mixture such that it is maintained as a slurry of the solid botanical substrate in the second aqueous medium.

33. A food grade extract produced by the process of claim 1.

34. A food product comprising the food grade extract of claim 33.

35. The food product of claim 34 wherein the food product is selected from the group consisting of confectionary products, drink products, frozen desserts, baked goods, breakfast cereals, condiments and dairy products.

36. A process for the production of a food grade extract comprising agitating a fluidized slurry comprising a food solid substrate, an aqueous solvent medium and a food grade reactive agent in a sealed reactor at a temperature of at least about 150° F. and a pressure of at least about 10 psig to provide an extract mixture comprising flavor components resulting from reactions between the food solid substrate and the reactive agent.

37. The process of claim 36 wherein the fluidized slurry is agitated in a sealed reactor at a temperature of at least about 180° F.

38. The process of claim 37 wherein the fluidized slurry is agitated in a sealed reactor at a temperature of no more than about 250° F.

39. The process of claim 36 wherein the food grade reactive agent includes at least one component selected from natural amino acids, sugars, botanical extracts, essential oils, natural essences, nucleic acids, protein hydrozylates, natural alcohols, and natural organic acids and salts thereof.

40. The process of claim 39 wherein the food grade reactive agent comprises one or more one natural amino acids or salts thereof; one or more sugars and one or more botanical extracts.

41. The process of claim 39 wherein the food grade reactive agent comprises one or more yeast extracts, one or more sugars and one or more essential oils.

42. The process of claim 36 wherein the food solid substrate comprises cocoa solids, roasted coffee beans, tea leaves or a mixture thereof.

43. The process of claim 36 wherein the food solid substrate comprises garlic, onion or a mixture thereof.

44. The process of claim 36 wherein the food solid substrate comprises fruit, vegetable, spice, herb or a mixture thereof.

45. The process of claim 36 wherein the aqueous solvent medium comprises one or more food grade alcohols.

46. The process of claim 45 wherein the food grade alcohol comprises ethanol, propanediol, glycerin, isopropyl alcohol or a mixture thereof.

47. A food grade extract produced by the process of claim 36.

48. A food product comprising the food grade extract of claim 47.
